(19) United States
(12) Patent Application Publication
(10) Pub. No.: US 2014/0157025 A1
(43) Pub. Date: Jun. 5, 2014

(54) STATIC FRAME DISPLAY FROM A MEMORY ASSOCIATED WITH A PROCESSOR OF A DATA PROCESSING DEVICE DURING LOW ACTIVITY THEREOF

(71) Applicants: RADHIKA RANJAN SONI, Pune (IN); Prafull SURYAWANSHI, Pune (IN)

(72) Inventors: RADHIKA RANJAN SONI, Pune (IN); Prafull SURYAWANSHI, Pune (IN)

(21) Appl. No.: 13/691,868

(22) Filed: Dec. 3, 2012

(51) Int. Cl. G06F 1/32

(52) U.S. Cl. CPC G06F 1/3293
USPC 713/323

(57) ABSTRACT

A method includes detecting an idle state of a processor of a data processing device based on initiation thereof through a driver associated with the processor and/or an operating system executing on the data processing device, and copying raw display data related to a static frame to be displayed during the idle state into a memory upon detection of the idle state, along with state information of the data processing device. The method also includes providing access to the copied raw display data to an output resource of the processor during the idle state, and converting the copied raw display data into a format suitable for rendering on a display unit. Further, the method includes power gating one or more engine(s) of the processor during the idle state while maintaining the output resource and the memory in a powered up state to reduce power consumption of the data processing device.

### FIELD OF TECHNOLOGY

This disclosure relates generally to data processing devices and, more particularly, to static frame display from a memory associated with a processor of a data processing device during low activity thereof.

### BACKGROUND

A data processing device (e.g., a desktop computer, a laptop computer, a notebook computer, a server, a mobile device) may include a processor communicatively coupled to a memory. The memory may be a temporary storage for display data related to frames to be displayed on a display unit of the data processing device. During an idle state of the processor, the individual frames to be displayed may not differ from one another. However, one or more engine(s) executing on the processor may still consume power, thereby contributing to power inefficiency of the data processing device.

### SUMMARY

Disclosed are a method, a device and/or a system of static frame display from a memory associated with a processor of a data processing device during low activity thereof.

In one aspect, a method includes detecting an idle state of a processor of a data processing device based on initiation thereof through a driver associated with the processor and/or an operating system executing on the data processing device, and copying raw display data related to a static frame to be displayed during the idle state into a memory associated with the processor upon detection of the idle state, along with state information of the data processing device. The method also includes providing access to the copied raw display data to an output resource of the processor during the idle state, and converting the copied raw display data into a format suitable for rendering on a display unit of the data processing device. Further, the method includes power gating one or more engine(s) of the processor during the idle state while maintaining the output resource and the memory in a powered up state to reduce a power consumption of the data processing device.

The one or more engine(s) of the processor may be a video memory engine and/or a display engine. The method may further include restoring power to the one or more engine(s) of the processor upon detection of high activity of the processor based on the stored state information of the data processing device in the memory. The memory may be a frame buffer, a local memory of the processor or a memory external to the processor and/or the processor may be a Graphics Processing Unit (GPU) or a Central Processing Unit (CPU).

The method may further include disconnecting the access to the memory by the output resource following the restoration of power to the one or more engine(s) upon detection of the high activity of the processor. The method may also include detecting the idle state of the processor through the operating system executing on the data processing device and/or a Cyclic Redundancy Check (CRC) between consecutive frames to be displayed on the display unit. The copied raw display data may include a number of display parameters, the number of display parameters including display timing, display resolution, display refresh rate and/or display color depth.

In another aspect, a data processing device includes a memory, a processor communicatively coupled to the memory, and a driver component associated with the processor and/or an operating system executing on the data processing device. The driver component is configured to initiate detection of an idle state of the processor, and to enable copying of raw display data in the processor related to a static frame to be displayed during the idle state into the memory upon detection of the idle state of the processor based frame, along with state information of the data processing device. The driver component is also configured to enable access to the copied raw display data in the memory to an output resource of the processor during the idle state thereof, and to enable conversion of the copied raw display data into a format suitable for rendering on a display unit of the data processing device through the processor.

Further, the driver component is configured to enable power gating of one or more engine(s) of the processor during the idle state thereof while maintaining the output resource and the memory in a powered up state to reduce a power consumption of the data processing device. The data processing device may also be configured to perform the supplementary operations discussed above.

In yet another aspect, a non-transitory medium, readable through a data processing device and including instructions embodied therein that are executable through the data processing device, is disclosed. The non-transitory medium includes instructions to detect an idle state of a processor of the data processing device based on initiation thereof through a driver associated with the processor and/or an operating system executing on the data processing device, and instructions to copy raw display data related to a static frame to be displayed during the idle state into a memory associated with the processor upon detection of the idle state of the processor based on the static frame, along with state information of the data processing device.

The non-transitory medium also includes instructions to provide access to the copied raw display data in the memory to an output resource of the processor during the idle state thereof, and instructions to convert the copied raw display data into a format suitable for rendering on a display unit of the data processing device through the processor. Further, the non-transitory medium includes instructions to power gate one or more engine(s) of the processor during the idle state while maintaining the output resource and the memory in a powered up state to reduce a power consumption of the data processing device.

The non-transitory medium may also include instructions to execute the supplementary operations discussed above.

The methods and systems disclosed herein may be implemented in any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE FIGURES

The embodiments of this invention are illustrated by way of example and not limitation in the figures of the accompanying drawings, in which like references indicate similar elements and in which:

FIG. 1 is a schematic view of a data processing device, according to one or more embodiments.

FIG. 2 is a schematic view of components of a processor of the data processing device of FIG. 1, according to one or more embodiments.

FIG. 3 is a schematic view of detection of an idle state of the processor of the data processing device of FIG. 1, according to one or more embodiments.

FIG. 4 is a schematic view of disconnecting access to a local memory by an output resource following restoration of power to one or more engine(s) of the processor of the data processing device of FIG. 1.

FIG. 5 is a schematic view of interaction between a driver component and the processor of the data processing device of FIG. 1 during execution of one or more engine(s) therethrough.

FIG. 6 is a process flow diagram detailing the operations involved in static frame display from a memory associated with the processor of the data processing device of FIG. 1 during low activity thereof, according to one or more embodiments.

Other features of the present embodiments will be apparent from the accompanying drawings and from the detailed description that follows.

### DETAILED DESCRIPTION

Example embodiments, as described below, may be used to provide a method, a device and/or a system of static frame display from a memory associated with a processor of a data processing device during low activity thereof. Although the present embodiments have been described with reference to specific example embodiments, it will be evident that various modifications and changes may be made to these embodiments without departing from the broader spirit and scope of the various embodiments.

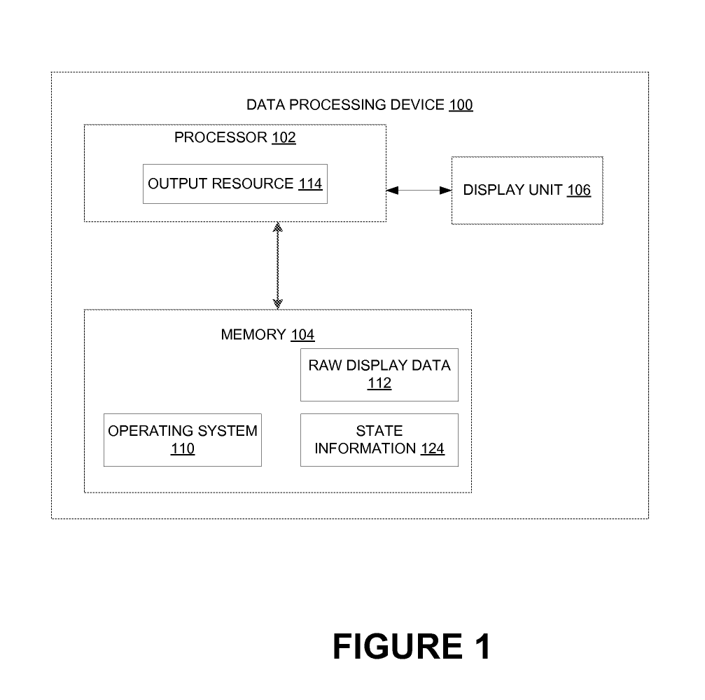

FIG. 1 shows a data processing device 100, according to one or more embodiments. In one or more embodiments, data processing device 100 may represent various forms of digital computers such as a laptop, a desktop, a workstation, a notebook computer, a netbook, a tablet, a Personal Digital Assistant (PDA), a server and a mobile device (e.g., a mobile phone). Other examples of data processing device 100 are within the scope of the exemplary embodiments discussed herein. In one or more embodiments, data processing device 100 may include a processor 102 (e.g., a Central Processing Unit (CPU), a Graphics Processing Unit (GPU)) communicatively coupled to a memory 104 (e.g., a volatile memory and/or a non-volatile memory), processor 102 being configured to address storage locations in memory 104. In one or more embodiments, output data associated with processing through processor 102 may be input to a multimedia processing unit (not shown) configured to perform encoding/decoding associated with the data. In one or more embodiments, the output of the multimedia processing unit may be rendered on a display unit 106 (e.g., Liquid Crystal Display (LCD) display, Cathode Ray Tube (CRT) monitor); FIG. 1 shows processor 102 being communicatively coupled to display unit 106.

It is obvious that an operating system 110 may execute on data processing device 100. FIG. 1 shows operating system 110 as being stored in memory 104 (e.g., non-volatile memory). In one or more embodiments, processor 102 may be in an idle state; a driver component (e.g., a software driver) associated with processor 102 and/or operating system 110 may initiate detection of the idle state of processor 102. For example, processor 102 may execute one or more engine(s) (e.g., modules) thereon prior to the idle state. The aforementioned one or more engine(s) may be an engine associated with a video memory and/or a display engine. Processor 102 may be executing instructions associated with rendering, for example, a three-dimensional (3D) game. In one or more embodiments, once the idle state of processor 102 is detected based on stasis with regard to a frame to be displayed, the driver component may enable copying of raw display data 112 related to the static frame (e.g., frame of an image) to be displayed during the idle state into memory 104. In one or more embodiments, state information 124 (e.g., data, metadata associated with a state of data processing device 100) of data processing device 100 may also be copied to memory 104 along with raw display data 112. Now, in one or more embodiments, an output resource 114 (e.g., a memory; memory 104 or another memory) of processor 102 may be provided access to the copied raw display data 112 in memory 104.

In one or more embodiments, the copied raw display data 112 may be converted (e.g., through a multimedia interface (not shown)) to an appropriate format suitable for rendering on display unit 106; the aforementioned conversion may be enabled through the driver component. In one or more embodiments, the driver component may also enable power gating the one or more engine(s) of processor 102 during the idle state thereof while maintaining output resource 114 and memory 104 in a powered up state; the aforementioned power gating may reduce a power consumption of data processing device 100. It is obvious that when processor 102 is configured to execute a number of engine(s), it is not required to power gate all of the engine(s). Power gating may be done as per system requirements or as per requirements of a user of data processing device 100.

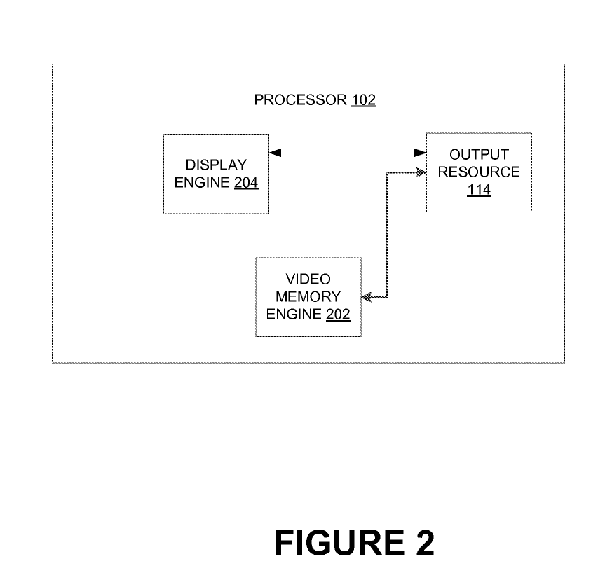

FIG. 2 shows components of processor 102 of FIG. 1, according to one or more embodiments. FIG. 2 shows video memory engine 202 and display engine 204 as an example, along with output resource 114. It is obvious that other engines are within the scope of the exemplary embodiments discussed herein. Once high activity of processor 102 is detected (e.g., through test instructions executing on processor 102, through a state or parameters of a bus (e.g., a system bus) to which processor 102 is coupled to), power to the power-gated one or more engine(s) of processor 102 may be restored based on the stored state information 124 in memory 104. Memory 104 may be a frame buffer (not shown), a local memory of processor 102 or a memory external to processor 102. Other forms of memory 104 are within the scope of the exemplary embodiments discussed herein.

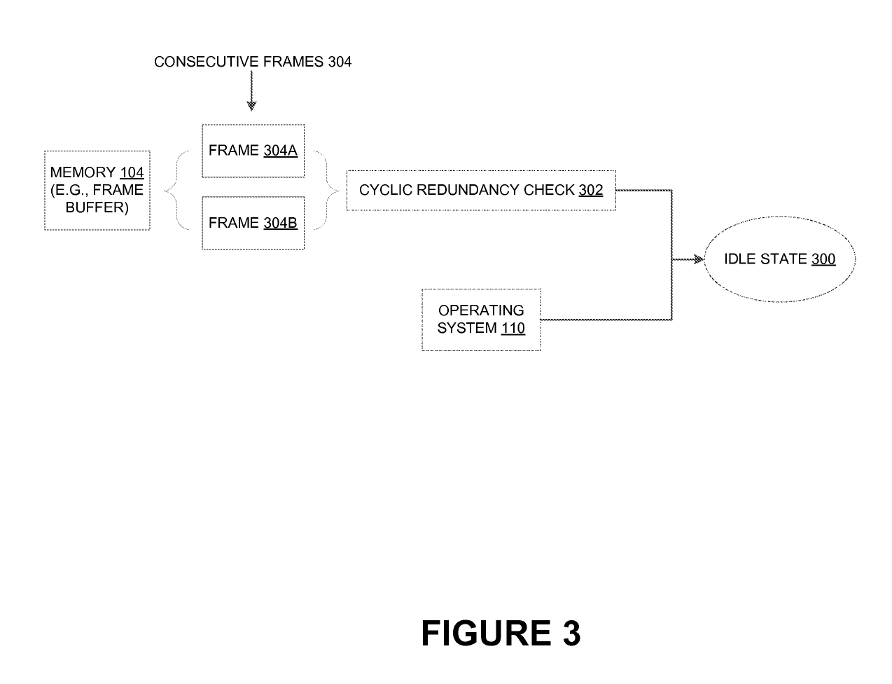

In one or more embodiments, access to memory 104 (e.g., local memory, frame buffer) by output resource 114 may be disconnected following restoration of power to the one or more engine(s) upon detection of high activity of processor 102. FIG. 3 shows detection of idle state 300 of processor 102. In one example embodiment, operating system 110 may detect idle state 300. Based on the detection of idle state 300 through operating system 110, the driver component may enable the processes discussed above. In another example embodiment, idle state 300 may be detected through a Cyclic Redundancy Check (CRC) 302 between consecutive frames 304 (e.g., frame 304A, frame 304B) to be displayed on display unit 106. CRC 302 may, for example, be part of a set of test instructions executable through processor 102. Idle state 300 may be determined based on no change being detected between frame 304A and frame 304B.

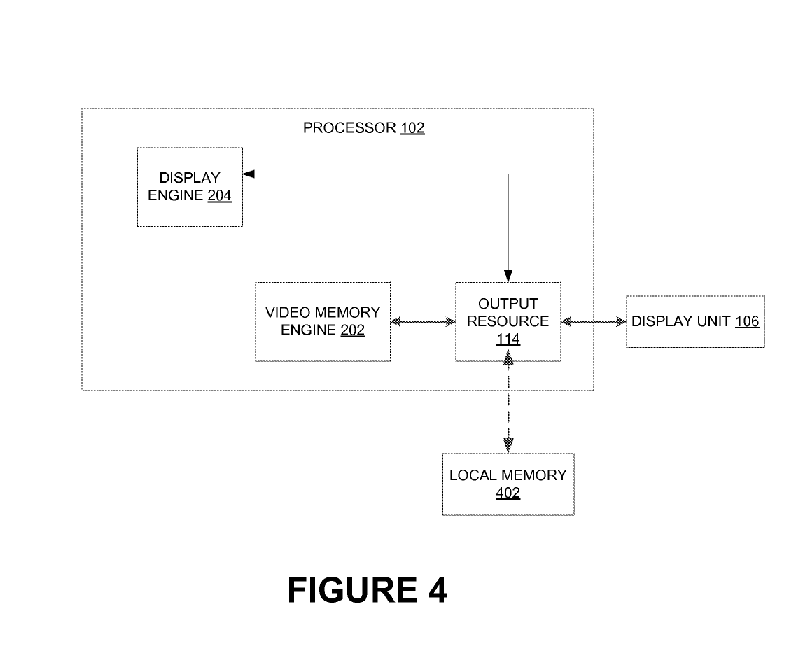

FIG. 4 shows disconnecting access to a local memory 402 (an example memory 104) by output resource 114 following restoration of power to the one or more engine(s) (e.g., video memory engine 202 and/or display engine 204) of processor 102. Now, regular operations may be resumed in data processing device 100. In one or more embodiments, copied raw display data 112 may include a number of display parameters such as display timing, display resolution, display refresh rate and display color depth. Other examples of display parameters are within the scope of the exemplary embodiments discussed herein.

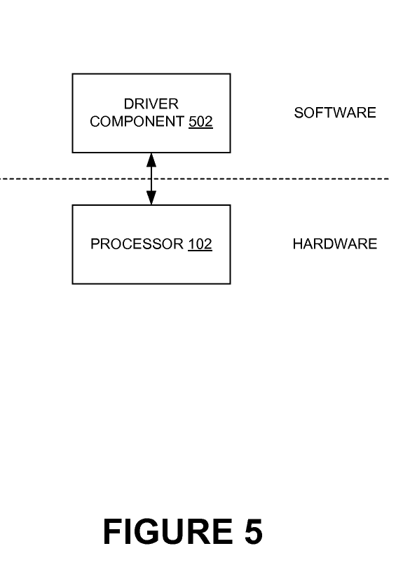

FIG. 5 shows interaction between a driver component (e.g., driver component 502) discussed above and processor 102 during execution of the one or more engine(s) through processor 102. In one or more embodiments, driver component 502 may initiate detection of idle state 300 of processor 102 and the subsequent operations discussed above; the detection may be initiated automatically based on user intervention on data processing device 100 (e.g., through clicking a button on a user interface, a physical button on data processing device 100), execution of an appropriate application therefor and/or loading of operating system 110. Other forms of initiation are within the scope of the exemplary embodiments discussed herein.

The driver component (e.g., driver component 502) or equivalent software thereof discussed above may be stored in memory 104 to be installed on data processing device 100 after a download through the Internet. Alternately, an external memory may be utilized therefor. Also, instructions associated with the driver component may be embodied on a non-transitory medium readable through data processing device 100 such as a Compact Disc (CD), a Digital Video Disc (DVD), a Blu-ray™ disc, a floppy disk, or a diskette etc. The aforementioned instructions may be executable through data processing device 100.

The set of instructions associated with the driver component or equivalent software thereof is not limited to specific embodiments discussed above, and may, for example, be implemented in operating system 110, an application program, a foreground or a background process, a network stack or any combination thereof. Other variations are within the scope of the exemplary embodiments discussed herein.

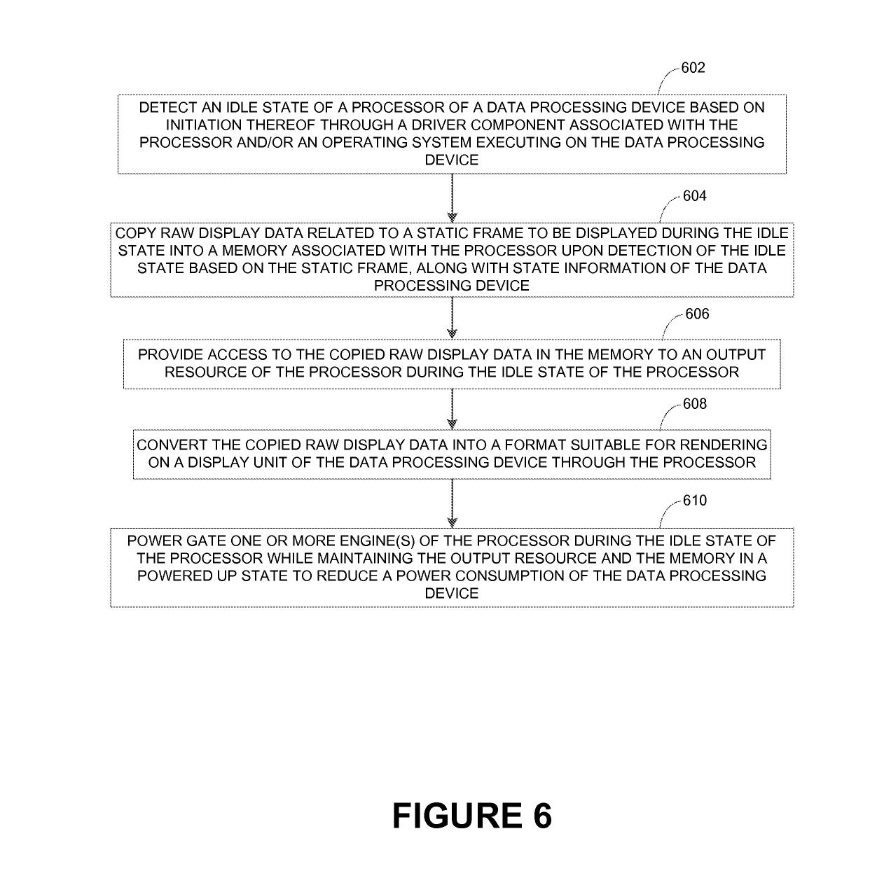

FIG. 6 shows a process flow diagram detailing the operations involved in static frame display from memory 104 associated with processor 102 of data processing device 100 during low activity thereof, according to one or more embodiments. In one or more embodiments, operation 602 may involve detecting idle state 300 of processor 102 based on initiation thereof through a driver (e.g., driver component 502) associated with processor 102 and/or operating system 110. In one or more embodiments, operation 604 may involve copying raw display data 112 related to a static frame to be displayed during idle state 300 into memory 104 upon detection of idle state 300 based on the static frame, along with state information 124 of data processing device 100.

In one or more embodiments, operation 606 may involve providing access to the copied raw display data 112 in memory 104 to output resource 114 of processor 102 during idle state 300. In one or more embodiments, operation 608 may involve converting the copied raw display data 112 into a format suitable for rendering on display unit 106 of data processing device 100 through processor 102. In one or more embodiments, operation 610 may then involve power gating one or more engine(s) of processor 102 during idle state 300 while maintaining output resource 114 and memory 104 in a powered up state to reduce a power consumption of data processing device 100.

An example scenario involving concepts associated with the exemplary embodiments discussed herein will now be described. A workstation (an example data processing device 100) user may wish to reduce power consumption during idle state 300 of processor 102 of data processing device 100. The one or more engine(s) executing on processor 102 may consume power even during idle state 300. Therefore, the user may wish to eliminate the aforementioned power inefficiency through detecting idle state 300 and executing subsequent operations discussed above enabled through driver component 502. Based on the detection and the subsequent operations, power consumption through the workstation may be reduced as discussed above.

Although the present embodiments have been described with reference to specific example embodiments, it will be evident that various modifications and changes may be made to these embodiments without departing from the broader spirit and scope of the various embodiments. For example, the various devices and modules described herein may be enabled and operated using hardware circuitry, firmware, software or any combination of hardware, firmware, and software (e.g., embodied in a non-transitory machine-readable medium). For example, the various electrical structure and methods may be embodied using transistors, logic gates, and electrical circuits (e.g., Application Specific Integrated Circuitry (ASIC) and/or Digital Signal Processor (DSP) circuitry).

In addition, it will be appreciated that the various operations, processes, and methods disclosed herein may be embodied in a non-transitory machine-readable medium and/or a machine accessible medium compatible with a data processing system (e.g., data processing device 100), and may be performed in any order (e.g., including using means for achieving the various operations).

Accordingly, the specification and drawings are to be regarded in an illustrative rather than a restrictive sense.

What is claimed is:

1. A method comprising:
detecting an idle state of a processor of a data processing device based on initiation thereof through a driver associated with at least one of the processor and an operating system executing on the data processing device;
copying raw display data related to a static frame to be displayed during the idle state into a memory associated with the processor upon detection of the idle state of the processor based on the static frame, along with state information of the data processing device;
providing access to the copied raw display data in the memory to an output resource of the processor during the idle state of the processor;
converting the copied raw display data into a format suitable for rendering on a display unit of the data processing device through the processor; and
power gating at least one engine of the processor during the idle state of the processor while maintaining the output resource and the memory in a powered up state to reduce a power consumption of the data processing device.

2. The method of claim 1, wherein the at least one engine of the processor is at least one of a video memory engine and a display engine.

3. The method of claim 1, further comprising restoring power to the at least one engine of the processor upon detection of high activity of the processor based on the stored state information of the data processing device in the memory.

4. The method of claim 3, wherein at least one of:
the memory associated with the processor is one of a frame buffer, a local memory of the processor and a memory external to the processor, and
the processor is one of a Graphics Processing Unit (GPU) and a Central Processing Unit (CPU).

5. The method of claim 3, further comprising:
disconnecting the access to the memory by the output resource following the restoration of power to the at least one engine upon detection of the high activity of the processor.

6. The method of claim 1, comprising detecting the idle state of the processor through at least one of: the operating system executing on the data processing device and a Cyclic Redundancy Check (CRC) between consecutive frames to be displayed on the display unit.

7. The method of claim 1, wherein the copied raw display data includes a plurality of display parameters, the plurality of display parameters including at least one of display timing, display resolution, display refresh rate and display color depth.

8. A data processing device comprising:
a memory;
a processor communicatively coupled to the memory; and
a driver component associated with at least one of the processor and an operating system executing on the data processing device, the driver component being configured to:
initiate detection of an idle state of the processor,
enable copying of raw display data in the processor related to a static frame to be displayed during the idle state into the memory upon detection of the idle state of the processor based on the static frame, along with state information of the data processing device,
enable access to the copied raw display data in the memory to an output resource of the processor during the idle state of the processor,
enable conversion of the copied raw display data into a format suitable for rendering on a display unit of the data processing device through the processor, and
enable power gating of at least one engine of the processor during the idle state of the processor while maintaining the output resource and the memory in a powered up state to reduce a power consumption of the data processing device.

9. The data processing device of claim 8, wherein the at least one engine of the processor is at least one of a video memory engine and a display engine.

10. The data processing device of claim 8, wherein the driver component is further configured to enable restoration of power to the at least one engine of the processor upon detection of high activity of the processor based on the stored state information of the data processing device in the memory.

11. The data processing device of claim 10, wherein at least one of:
the memory is one of a frame buffer, a local memory of the processor and a memory external to the processor, and
the processor is one of a GPU and a CPU.

12. The data processing device of claim 10, wherein the driver component is further configured to enable:
disconnecting the access to the memory by the output resource following the restoration of power to the at least one engine upon detection of the high activity of the processor.

13. The data processing device of claim 8, wherein the driver component is configured to enable detection of the idle state of the processor through at least one of: the operating system executing on the data processing device and a CRC between consecutive frames to be displayed on the display unit.

14. The data processing device of claim 8, wherein the copied raw display data includes a plurality of display parameters, the plurality of display parameters including at least one of display timing, display resolution, display refresh rate and display color depth.

15. A non-transitory medium, readable through a data processing device and including instructions embodied therein that are executable through the data processing device, comprising:
instructions to detect an idle state of a processor of the data processing device based on initiation thereof through a driver associated with at least one of the processor and an operating system executing on the data processing device;
instructions to copy raw display data related to a static frame to be displayed during the idle state into a memory associated with the processor upon detection of the idle state of the processor based on the static frame, along with state information of the data processing device;
instructions to provide access to the copied raw display data in the memory to an output resource of the processor during the idle state of the processor;
instructions to convert the copied raw display data into a format suitable for rendering on a display unit of the data processing device through the processor; and
instructions to power gate at least one engine of the processor during the idle state of the processor while maintaining the output resource and the memory in a powered up state to reduce a power consumption of the data processing device.

16. The non-transitory medium of claim 15, comprising instructions to power gate at least one of a video memory engine and a display engine of the processor as the at least one engine.

17. The non-transitory medium of claim 15, further comprising instructions to restore power to the at least one engine of the processor upon detection of high activity of the processor based on the stored state information of the data processing device in the memory.

18. The non-transitory medium of claim 15, comprising:
instructions to copy the raw display data into one of a frame buffer, a local memory of the processor and a memory external to the processor.

19. The non-transitory medium of claim 17, further comprising:
instructions to disconnect the access to the memory by the output resource following the restoration of power to the at least one engine upon detection of the high activity of the processor.

20. The non-transitory medium of claim 15, comprising instructions to detect the idle state of the processor through at least one of: the operating system executing on the data processing device and a CRC between consecutive frames to be displayed on the display unit.
